(19) United States
(12) Patent Application Publication
(10) Pub. No.: US 2006/0122804 A1
(43) Pub. Date: Jun. 8, 2006

(54) Method and system for simulative measurement demo

(75) Inventors: Chih-Kuang Chang, Tu-Cheng (TW); Xin-Yuan Wu, Shenzhen (CN); Xiao-Dan Tang, Shenzhen (CN); Jie-Rong Chen, Shenzhen (CN)

Correspondence Address: MORRIS MANNING & MARTIN LLP, 1600 ATLANTA FINANCIAL CENTER, 3343 PEACHTREE ROAD, NE, ATLANTA, GA, 30326-1044, US

(73) Assignee: HON HAI Precision Industry Co., LTD., Tu-Cheng City (TW)

(21) Appl. No.: 11/292,177

(22) Filed: Dec. 1, 2005

(30) Foreign Application Priority Data
Dec. 3, 2004 (TW) 93137391

(51) Int. Cl. G01D 1/00

(52) U.S. Cl. 702/127

(57) ABSTRACT

A system for simulative measurement demo is used for demonstrating simulative measurement by creating a simulative probe (2′) to measure points in an image (3′) of an under-measurement object (3), which includes an application server (1). The application server includes: a probe setting module (11) for setting technology index of the simulative probe; a parameter setting module (12) for setting measurement parameters; an image loading module (13) for loading an image of the under-measurement object; a point measurement module (14) for determining measuring points in the image and for obtaining coordinates of the measuring points; a simulative demo module (15) for demonstrating measurement by creating a simulative probe, and for generating a measure path (7); and a real measurement controlling module (16) for controlling the probe to measure the under-measurement object according to the measure path. A related method is also disclosed.

### BACKGROUND OF THE INVENTION

1. Field of the Invention

The present invention relates to Computer Aided Verification (CAV) systems and methods, and more particularly to a system and method for simulative measurement demo.

2. General Background

Measurement technology has been developing for quite a long time. Humankind has devised various measurement devices to meet new demands for measurement as they arose. Nevertheless, many enterprises still perform measurement by employing numerous manual tasks, thus slowing down measurement. Especially, measurement by manual tasks is apt to bring accidents, such as collision between the probe and the under-measurement object during measuring coordinates of points on the under-measurement object. Although systems for simulative measurement offline are provided, they are not user-friendly because they lack three-dimensional mode, which causes measurement status hard to be observed directly. Moreover, current technology including simulative measurement offline cannot guarantee safe working during measurement. For example, measure path and motion speed of a simulative probe which is created according to technology index of a probe installed on a measure machine cannot be shown when the simulative probe is moved during demonstration, neither the position where the simulative probe collide with the under-measurement object can be shown.

What is needed, therefore, is a system and method which can demonstrate simulative measurement by utilizing a simulative probe to measure points selected in an image according to which the under-measurement object is so manufactured, thereby generating a measure path for guiding operative movement of the practical probe during measurement and effectively preventing any unwanted collision from occurring between the practical probe and the under-measurement object.

### SUMMARY

A system for simulative measurement demo in accordance with a preferred embodiment includes an application server and a database which is stored with images. The application server includes: a probe setting module for setting technology index of the probe; a parameter setting module for setting measurement parameters; an image loading module for loading a predetermined image from the database to the server, wherein the under-measurement object is manufactured according to the predetermined image; a point measurement module for determining measuring points in the image and for obtaining coordinates of the measuring points; a simulative demo module for demonstrating simulative measurement via creating a simulative probe according to the technology index, and for generating a measure path based on the determined measuring points; and a real measurement controlling module for outputting the measure path and the determined measuring points to a measurement machine which controls a probe to measure the under-measurement object according to the measure path.

A method for simulative measurement demo in accordance with another preferred embodiment includes the steps of: setting technology index of a probe which is used to measure an under-measurement object; setting measurement parameters; loading an image by which the under-measurement object is so manufactured; determining measuring points of the image and obtaining coordinates of the measuring points; demonstrating simulative measurement by creating a simulative probe according to the technology index; generating a measure path of the simulative probe; determining whether a collision between the simulative probe and the elements of the drawing exists; marking the position where the collision exists if a collision exists in the simulative demo.

Other advantages and novel features of the present invention will become more apparent from the following detailed description of preferred embodiments when taken in conjunction with the accompanying drawings, in which:

### BRIEF DESCRIPTION OF THE IMAGES

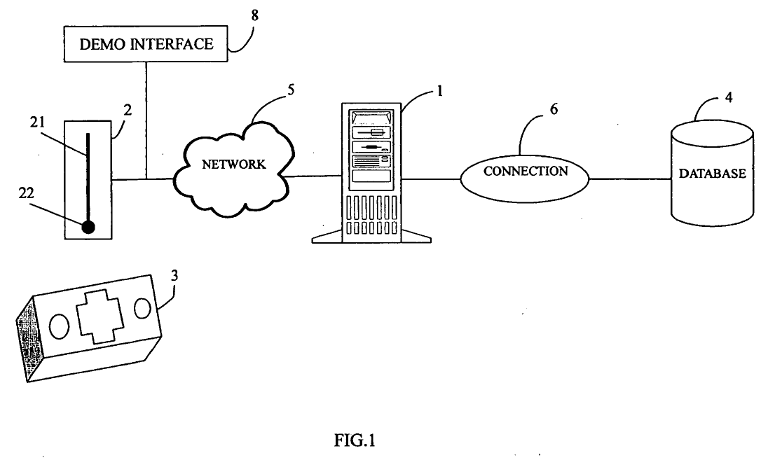

FIG. 1 is a schematic diagram of hardware configuration of a system for simulative measurement demo in accordance with a preferred embodiment of the present invention;

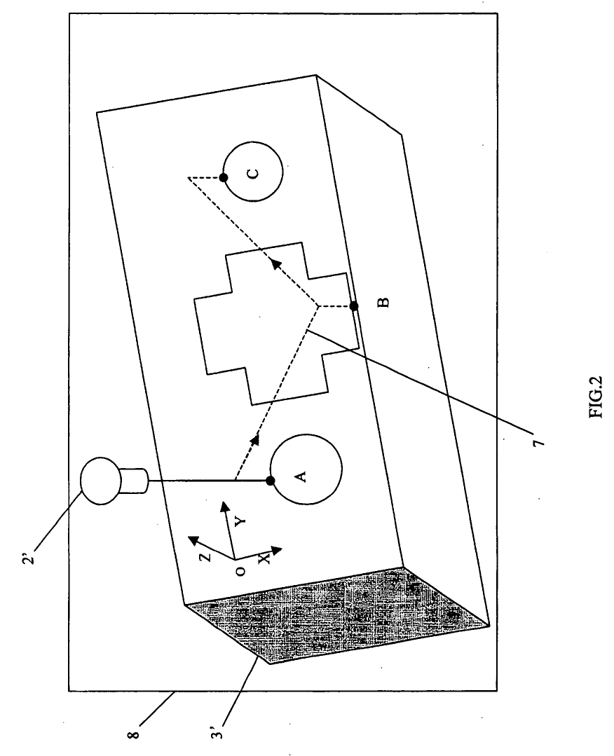

FIG. 2 is a simulative demo interface for performing the system of FIG. 1;

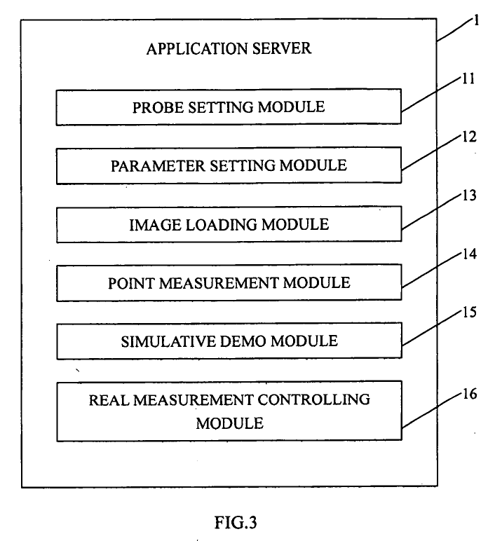

FIG. 3 is a schematic diagram of main software function modules of the application server of FIG. 1; and

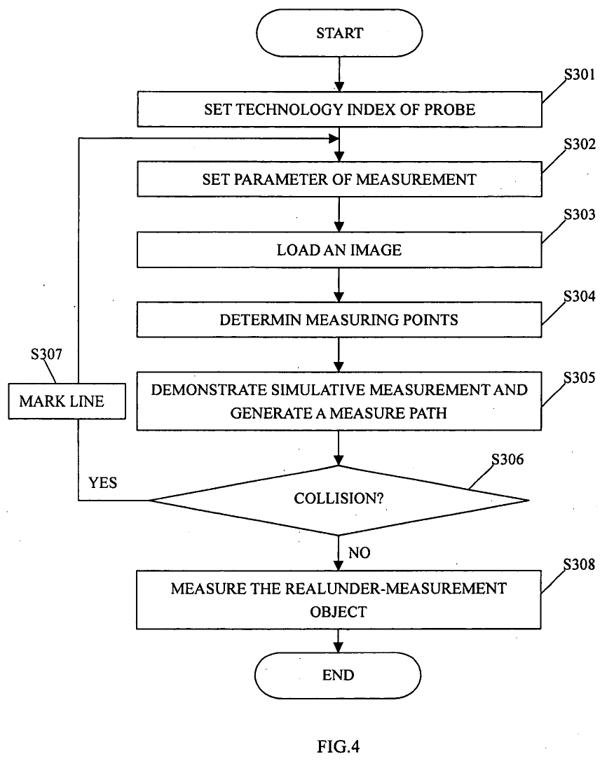

FIG. 4 is a flowchart of a method for simulative measurement demo in accordance with a preferred embodiment of the present invention.

### DETAILED DESCRIPTION OF PREFERRED EMBODIMENTS

FIG. 1 is a schematic diagram of hardware configuration of a system for simulative measurement demo (hereinafter, “the system”) in accordance with a preferred embodiment of the present invention. The system includes an application server 1, a probe 2, a simulative demo interface 8 and a database 4. The application server 1 communicates with the probe 2 via a network 5. The network 5 may be an intranet, the Internet, or any other suitable type of communications link. The application server 1 is connected with the database 4 via a connection 6. The connection 6 is a database connectivity, such as an ODBC (OpenDatabase Connectivity) or a JDBC (Java Database Connectivity).

Also referring to FIG. 2 and FIG. 3, the application server 1 is configured with software modules for implementing a series of simulative measurements in which a simulative probe 2′ is shown on an simulative demo interface 8 for measuring points in an image 3′ by which the real under-measurement object 3 is so manufactured. The simulative demo interface 8 may be a personal computer or a terminal connected to the network 5 for performance of simulation measurement. The application server 1 implements simulative measurements by loading the image 3′ stored in the database 4 for generating a measure path 7 of the simulative probe 2′, and for controlling the probe 2 to measure the object 3 according to the measure path 7. The probe 2 is configured with a pole 21 and a sphere 22, and it is detachable connected to a measure machine, wherein the sphere 22 is set on the tip of the pole 21 for detecting the interface of the object 3 and for generating a trigger signal to collect measurement data. The database 4 is used for storing the image by which the under-measurement object 3 is so manufactured.

For example, if the probe 2 is to measure different points on an upper surface of the under-measurement object 3 located on the X-Y plane. During practical measurement, the probe 2 is controlled by a measure machine (not shown) for moving laterally in parallel to the X-Y plane from one measuring point to another measuring point. The probe 2 is installed on the measure machine, which is known in this field and not the part of the invention. Whenever the probe 2 is moved laterally to a position just above a new measuring point, the measure machine will stop and change the moving direction from lateral to normal and approach the probe 2 down to touch the new measuring point.

Referring to FIG. 2, the simulative demo interface 8 shows a measure path 7 that the simulative probe 2′ measures the image 3′ by which the under-measurement object 3 is so manufactured. The simulative probe 2′ is created according to technology index of the probe 2 (described in detail in relation to FIG. 3). Point 0 is an origin of a coordinate system X-Y-Z. Points A, B and C are measuring points which are determined according to measurement demands, and arrows on the measure path 7 denotes the moving direction of the simulative probe 2′.

FIG. 3 is a schematic diagram of main software function modules of the application server 1. The application server 1 includes a probe setting module 11, a parameter setting module 12, an image loading module 13, and a point measurement module 14, a simulative demo module 15 and a real measurement controlling module 16.

The probe setting module 11 is used for determining the style of the simulative probe 2′ and setting technology index of the simulative probe 2′ based on the image 3′ of the under-measurement object 3. Once the style of the simulative probe 2′ is proved to perform well during simulation measurement, the real probe 2 is so determined. The style of the probe 2 may be a CMM (Computerized Modular Monitoring) probe, a CCD (Charge Coupled Device) probe or other probes. The technology index of the probe 2 mainly includes: diameter of the sphere 22, the total length of the probe 2, the diameter of the pole 21 and effective working length. The total length of the probe 2 is the length from one distal end of the pole 21 to the center of the sphere 22, where the probe 2 is connected to the measure machine by the distal end of the pole 21. The effective working length is the length from the center of the sphere 22 to the point where the sphere 22 touches the under-measurement object 3.

The parameter setting module 12 is used for setting measurement parameters, wherein the measurement parameters includes the following. Proximity distance is defined as a safe distance that the probe 2 needs to slow down when it approaches along a normal direction to the measuring point of the object 3. Retreat distance is defined as a specific distance that the probe 2 needs to move upward along a normal direction away from the measuring point of the under-measurement object 3 after performing measurement touch with the measuring point of the under-measurement object 3. Traveling speed is defined as a speed at which the probe 2 moves laterally from a measuring point to another measuring point of the object 3. Proximating speed is defined as the speed at which the probe 2 approaches downward to the measuring point along a normal direction. Retreat speed is defined as a speed at which the probe 2 retreats upward away from the measuring point along a normal direction after the probe 2 has touched the measuring point of the under-measurement object 3. Safety surface is defined as a virtual surface on which the probe 2 moves laterally without colliding with the object 3 from one measuring point to another measuring point. When the probe 2 moves from one measuring point to another measuring point, the probe 2 should travel laterally on the safety surface in order to avoid collision with the under-measurement object 3. The measurement parameters may be changed according to measurement demands.

The image loading module 13 is used for loading the image 3′ of the under-measurement object 3 stored in the database 4, wherein the under-measurement object is manufactured according to the image 3′. The image 3′ including following elements: points, lines, surfaces, circles and arcs, and so on.

The point measurement module 14 is used for determining measuring points in the image 3′ and for obtaining coordinates of the measuring points. The measuring points are determined according to measurement demands.

The simulative demo module 15 is used for demonstrating simulative measurement by creating a simulative probe 2′, and for generating a measure path 7. The simulative demo module 15 is also used for determining whether any collision between the simulative probe 2′ and the elements of the image 3′ exists during the simulative demo. The simulative probe 2′, which is created according to the technology index set by the probe setting module 11, simulatively measures the measuring points according to the parameters set by the parameter setting module 12. After finishing simulative measuring, the simulative demo module 15 generates a measure path 7, which is formed by a few straight line sections connected one by one as shown in FIG. 2. The collision between the simulative probe 2′ and the elements of the image 3′ can be detected via observing the measure path 7. Any line section of the measure path 7 where collision exists in simulative demo is marked to remind the user to amend corresponding measurement parameters until no collision exists.

The real measurement controlling module 16 is used for controlling the probe 2 to measure the under-measurement object 3 according to the measure path 7 traced and determined by the simulative probe 2′ when there is no collision occurring during the simulative measurement demo. Once the measure path 7 is determined, the measure path 7 is invoked to control the real machine to operate the probe 2 for measuring the under-measurement object 3.

FIG. 4 is a flowchart of a method for simulative measurement demo in accordance with a preferred embodiment of the present invention. In step S301, the probe setting module 11 determines the style of the probe 2 and sets technology index of the probe 2 according to the under-measurement object 3. In step S302, the parameter setting module 12 sets measurement parameters. In step S303, the image loading module 13 loads an image 3′ from the database 4 by which the under-measurement object 3 is so manufactured.

In step S304, the point measurement module 14 determines measuring points of the image 3′ and obtains coordinates of the measuring points. The measuring points are determined according to measurement demands. An X-Y-Z coordinates system is build firstly, however, the X-Y-Z coordinates system is not to be construed as being limited thereto. Any point of the image 3′ may be set as an origin of the X-Y-Z coordinates system, and the coordinates of the other points will be accordingly confirmed. The measuring points of the image 3′ according to measurement demands should be determined. Moreover, the coordinates system may be amended if the coordinates are not adapt to measurement demands. In step S305, the simulative demo module 15 demonstrates simulative measurement via creating a simulative probe 2′, and generates a measure path 7. In step S306, the simulative demo module 15 determines whether a collision between the simulative probe 2′ and the elements of the image 3′ exists. In step S307, if a collision exists in the simulative demo, the simulative demo module 15 marks the line section where collision exists to remind the user to amend corresponding parameters. Then, the procedure goes to step S302, the parameter setting module 12 resets the measurement parameter. Otherwise, if no collision exists in the simulative demo, in step S308, the real measurement controlling module 16 controls the measurement machine to operate the probe 2 to measure the under-measurement object 3 according to the measure path 7.

Although the present invention has been specifically described on the basis of a preferred embodiment and a preferred method, the invention is not to be construed as being limited thereto. Various changes or modifications may be made to said embodiment and method without departing from the scope and spirit of the invention.

We claim:

1. A system for simulative measurement demo on an under-measurement object comprising:
a probe setting module for setting technology index of a real probe;
a parameter setting module for setting measurement parameters;
an image loading module for loading an image by which the under-measurement object is so manufactured;
a point measurement module for determining measuring points in the image, and for obtaining coordinates of the measuring points; and
a simulative demo module for demonstrating simulative measurement by creating a simulative probe according to the technology index of the real probe, and for generating a measure path.

2. The system as claimed in claim 1, wherein the simulative demo module is further used for determining whether any collision between the simulative probe and the image exists in the simulative demo.

3. The system as claimed in claim 2, wherein the simulative demo module is further used for marking the position where the simulative probe collides the elements of the image in simulative demo.

4. The system as claimed in claim 1, wherein the application server further comprises a real measurement controlling module for controlling the probe to measure the under-measurement object according to the measure path.

5. A method for simulative measurement demo on and under-measurement object, comprising the steps of:
setting technology index of the probe;
setting measurement parameters;
loading an image of the under-measurement object;
determines measuring points of the image and obtaining coordinates of the measuring points;
demonstrating simulative measurement via creating a simulative probe according to the technology index; and
generating a measure path of the simulative probe.

6. The method according to claim 5, further comprising the step of determining whether a collision between the simulative probe and the elements of the image exists.

7. The method according to claim 6, wherein the step of determining whether a collision between the simulative probe and the elements of the image occurs comprises the steps of:
marking the position where the collision exists if a collision exists in the simulative demo; and
controlling the probe to measure the under-measurement object according to the measure path if no collision exists in the simulative demo.

8. A method for simulating measurement of an object, comprising the steps of:
defining a simulative probe according to available data of probes used to practically measure an object;
retrieving available image data of said object;
displaying said simulative probe and an image of said object based on said image data in a viewable environment;
retrieving measurement requirements applicable to said object; and
generating data of a measure path of said probes along said object according to simulation of said simulative probe moving along said measure path on said image of said object in said viewable environment and adjustment of said measure path to avoid any collision of said probes with said object based on said simulation.

9. The method according to claim 8, further comprising the step of setting measure points on said image of said object in said viewable environment according to said image data of said object before said path-data generating step.
